(19) United States
(12) Patent Application Publication
(10) Pub. No.: US 2012/0036294 A1
(43) Pub. Date: Feb. 9, 2012

(54) COMPUTER INTEGRATED DISPLAY INTEGRATED DISPLAY AND CONTROL METHOD OF THE SAME

(75) Inventor: Seung-pok LEE, Suwon-si (KR)

(73) Assignee: Samsung Electronics Co., Ltd, Suwon-si (KR)

(21) Appl. No.: 13/167,242

(22) Filed: Jun. 23, 2011

(30) Foreign Application Priority Data
Aug. 9, 2010 (KR) 10-2010-0076190

(51) Int. Cl. G06F 13/14

(52) U.S. Cl. 710/63

(57) ABSTRACT

A computer integrated display and a control method of the same, the computer integrated display including at least one built-in universal serial bus (USB) device, a USB controller to control the built-in USB device, a USB output connector which is connected to a USB cable, a switch, and a controller to control the switch to connect the built-in USB device to the USB controller or the USB output connector. Accordingly, a function of a built-in USB device is provided to an external device communicatively coupled to the computer integrated display and a control method of the same.

### CROSS-REFERENCE TO RELATED APPLICATIONS

This application claims priority under 35 U.S.C. §119(a) from Korean Patent Application No. 10-2010-0076190, filed on Aug. 9, 2010 in the Korean Intellectual Property Office, the disclosure of which is incorporated herein in its entirety by reference.

### BACKGROUND

1. Field of the Invention

Apparatuses and methods consistent with the exemplary embodiments of the present general inventive concept relate to a computer integrated display computer integrated display and a control method of the same, and more particularly, to a computer integrated display computer integrated display and a control method of the same which includes a universal serial bus (USB) device.

2. Description of the Related Art

As one of desktop computers, an all-in-one computer refers to a computer that integrates elements of a computer main body to a rear side of a display unit. The all-in-one computer is widely used since it has a simple configuration and takes a small space without an additional display apparatus such as a monitor.

New and expensive functions such as a camcorder, a microphone, and among others, a touch panel are integrated to the all-in-one computer, which raises utilization of the all-in-one computer.

Types and performance of peripheral devices which may be connected to the computer have been developed in various ways, and data communication between the computer and the peripheral devices is performed on the basis of a universal serial bus (USB) standard.

### SUMMARY

Accordingly, one or more exemplary embodiments of the present general inventive concept provide a computer integrated display computer integrated display and a control method of the same which provides a function of a built-in universal serial bus (USB) to the outside.

Exemplary embodiments of the present general inventive concept also provide a computer integrated display computer integrated display and a control method of the same which enables a user to select a function of a built-in USB device to be provided to the outside.

Exemplary embodiments of the present general inventive concept also provide a computer integrated display and a control method of the same which shares a display unit having a touch panel function with an external device.

Additional features and utilities of the present general inventive concept will be set forth in part in the description which follows and, in part, will be obvious from the description, or may be learned by practice of the present general inventive concept.

Exemplary embodiments of the present general inventive concept provide a computer integrated display including at least one built-in universal serial bus (USB) device, a USB controller to control the at least one built-in USB device; a USB output connector which is connected to a USB cable, a switch, and a controller to control the switch to connect the at least one built-in USB device to the USB controller or the USB output connector.

The computer integrated display may further include a user input unit to set a connection of the switch, and the controller may connect the at least one built-in USB device to the USB controller or the USB output connector according to a setting by the user input unit.

The USB output connector may be different in shape from a USB input connector which is connected to an external USB device.

The controller may connect the at least one built-in USB device to the USB output connector when the USB output connector is connected to the USB cable.

The USB output connector may have the same shape as a USB input connector that is connected to an external USB device.

The controller may determine whether an external device connected to one end of the USB cable is a USB device when the USB output connector is connected to an opposite end of the USB cable, and connect the at least one built-in USB device to the USB output connector when it is determined that the external device is not the USB device.

The switch may include a first switch to connect the built-in USB device to the USB controller or a predetermined node, and a second switch to connect the USB output connector to the USB controller or the node.

The controller may determine whether an external device connected to one end of the USB cable is a USB device when the USB output connector is connected to an opposite end of the USB cable, and connect the first and second switches to the node when it is determined that the external device is not the USB device.

The controller may determine whether an external device connected to one end of the USB cable is a USB device when the USB output connector is connected to an opposite end of the USB cable, and control the first and second switches to connect the built-in USB device and the USB output connector to the USB controller when it is determined that the external device is the USB device.

The built-in USB device may be include two or more USB devices, and the number of the USB output connector may correspond to the number of the two or more built-in USB device.

The built-in USB device may be include two or more USB devices, and the computer integrated display may further include a user input unit which is provided to connect one of the at least two of built-in USB devices to the USB output connector.

The at least one built-in USB device may include at least one of a touch panel, a camera, a microphone and a speaker.

Exemplary embodiments of the present general inventive concept may also provide a control method of a computer integrated display which comprises at least one built-in universal serial bus (USB) device, a USB controller to control the built-in USB device, and a USB output connector to connect a USB cable, the control method including determining whether an external device that is connected to one end of the USB cable is a USB device when the USB output connector is connected to an opposite end of the USB cable, and connecting the at least one built-in USB device to the USB output connector when it is determined that the external device is not the USB device.

The a least one built-in USB device may include two or more USB devices, and the method may further include receiving a selection signal to connect one of the two or more built-in USB devices to the USB output connector.

Exemplary embodiments of the present general inventive concept may also provide a control method of a computer integrated display which includes at least one built-in universal serial bus (USB) device, a USB controller to control the built-in USB device, and a USB output connector to connect a USB cable, the control method including receiving a setting signal to connect the built-in USB device to the USB controller or the USB output connector, and connecting the built-in USB device to the USB controller or the USB output connector according to the setting signal.

The at least one built-in USB device comprises at least one of a touch panel, a camera, a microphone and a speaker.

Exemplary embodiments of the present general inventive concept also provide a method of controlling a computer integrated display including at least one built-in universal serial bus (USB) device, a USB controller to control the at least one built-in USB device, and a USB output connector, the method including determining whether an external device that is communicatively coupled to the computer integrated display is a USB device, when it is determined that the external device is not a USB device, connecting the external device to a USB output connector to receive input from the external device and to control the at least one built-in USB device, and when it is determined that the external device is a USB device, connecting the external device to the USB controller to receive input from the external device and to control the at least one built-in USB device.

The method may also include where the at least one built-in USB device includes two or more USB devices, and the received input from the external device includes receiving a selection from the external device of at least one of the two or more built-in USB devices, and controlling the operation of the selected built-in USB devices with the external device.

The method may also include switching between the USB output connector and the USB controller according to the determination of whether the external device that is communicatively coupled to the computer integrated display is a USB device.

### BRIEF DESCRIPTION OF THE DRAWINGS

The above and/or other utilities of the present general inventive concept will become apparent and more readily appreciated from the following description of the exemplary embodiments, taken in conjunction with the accompanying drawings, in which:

FIG. 1 illustrates an external computer which is connected to a computer integrated display according to exemplary of the present general inventive concept;

FIG. 2 is a control block diagram illustrating a computer integrated display according to exemplary embodiments of the present general inventive concept;

FIG. 3 illustrates a first state of a switch according to exemplary embodiments of the present general inventive concept;

FIG. 4 illustrates a second state of the switch according to exemplary embodiments of the present general inventive concept;

FIG. 5 is a control flowchart illustrating a control method of the computer integrated display according to exemplary embodiments of the present general inventive concept;

FIG. 6 is a control block diagram illustrating a computer integrated display according to exemplary embodiments of the present general inventive concept;

FIG. 7 is a control flowchart illustrating a control method of the computer integrated display according to exemplary embodiments of the present general inventive concept;

FIG. 8 is a control flowchart illustrating a control method of the computer integrated display according to exemplary embodiments of the present general inventive concept;

FIG. 9 is a control block diagram illustrating a computer integrated display according to exemplary embodiments of the present general inventive concept; and

FIG. 10 is a control block diagram illustrating a computer integrated display according to exemplary embodiments of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

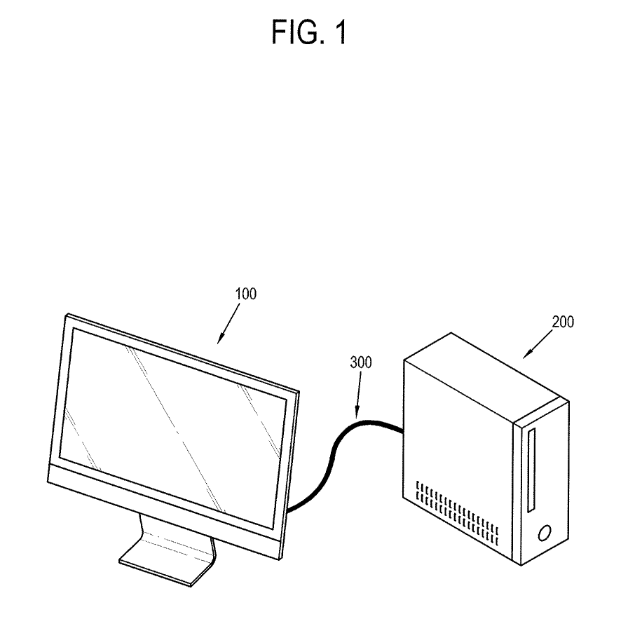

FIG. 1 illustrates an external computer which is connected to a computer integrated display according to exemplary embodiments of the present general inventive concept. One of two computers in FIG. 1 is a computer integrated display 100 which is called an all-in-one computer (hereinafter, to be called all-in-one computer), and the other one is a typical desktop computer 200 which is connected to a monitor. The all-in-one computer 100 is also a kind of the desktop computer that integrates all functions to a rear side of a display unit. The all-in-one computer is not additionally connected with a display apparatus such as a monitor, and thus has a simple configuration and takes a smaller space, which is why it is widely used. An advantage of the all-in-one computer 100 is that it can share a monitor with an external computer (e.g., desktop computer 200). In recent years, a monitor of the all-in-one computer 100 is connected to an external computer (e.g., desktop computer 200) by high definition multimedia interface (HDMI).

The two computers 100 and 200 can be connected to each other by a universal serial bus (USB) cable 300 which is based on USB as one of input/output standards used for connecting a computer to a peripheral device. The present invention exemplifies an all-in-one computer, but is not limited thereto, and may include any electronic device as long as such device includes a USB device that is driven by the USB standard.

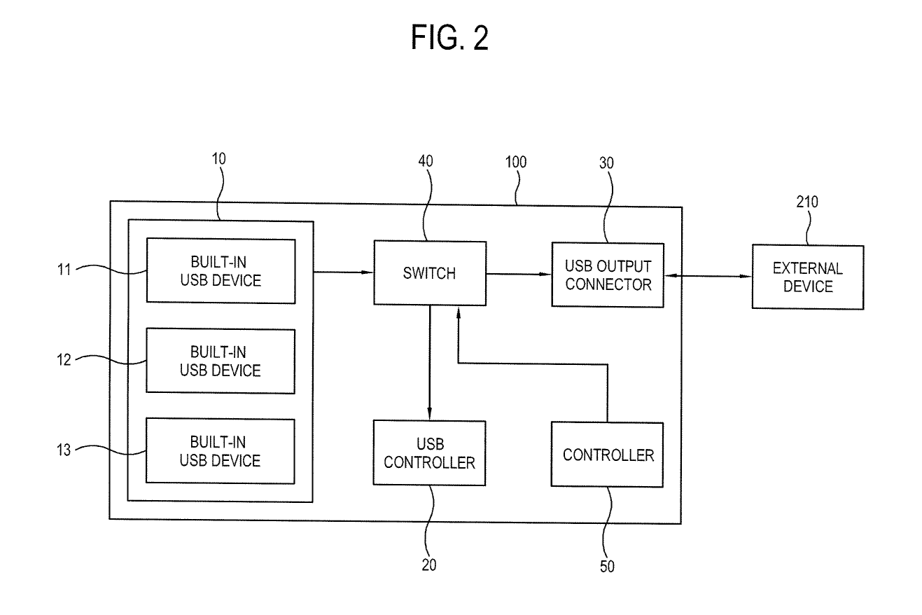

FIG. 2 is a control block diagram of the all-in-one computer 100 according to exemplary embodiments of the present general inventive concept. As illustrated therein, the all-in-one computer 100 can include built-in USB devices 10 (which may include built-in USB device 11, built-in USB device 12, and built-in USB device 13, and any additional number of built-in USB devices), a USB controller 20 to control the built-in USB devices 10, a USB output connector 30, a switch 40, and a controller 50 to control the foregoing elements. According to exemplary embodiments of the present general inventive concept, an external device 210 which is connected to the all-in-one computer 100 may include the desktop computer 200 illustrated in FIG. 1. The external device 210 can include a USB port (not illustrated), and can be connected to the all-in-one computer 100 by a cable connecting a USB port (e.g., USB cable 300) and the USB output connector 30.

The built-in USB devices 10 can be one or more electronic devices that can communicate with other electronic devices via the USB communication interface. The built-in USB devices 10 can be USB devices which are built in the all-in-one computer 100 instead of being connected to the computer 100 by an additional cable. For example, the built-in USB devices 10 may include a touch panel, a digital camera, a microphone or a speaker. The built-in USB devices 10 is plural in FIG. 1 (e.g., the built-in USB devices 10 include built-in device 11, built-in device 12, and built-in device 13), but is not limited thereto, and the all-in-one computer 100 may include only one built-in USB device.

The USB controller 20 can be a semiconductor chip, integrated circuit, application specific integrated circuit, programmable logic device, field programmable gate array, and/or any other suitable device to carry out the exemplary embodiments of the present general inventive concept which is provided to control a communication between USB devices. and the USB controller 20 may support two USB devices through a root hub. For convenience, the USB controller 20 is illustrated as a single block connected to the plurality of built-in USB devices 10, but the specific configuration and the number of the USB controller 20 may vary depending on the number of the built-in USB devices 10 and an internal configuration of the all-in-one computer 100.

The USB output connector 30 can include a port to be connected to a USB cable, and can have the same shape as a USB input connector to be connected to the USB device.

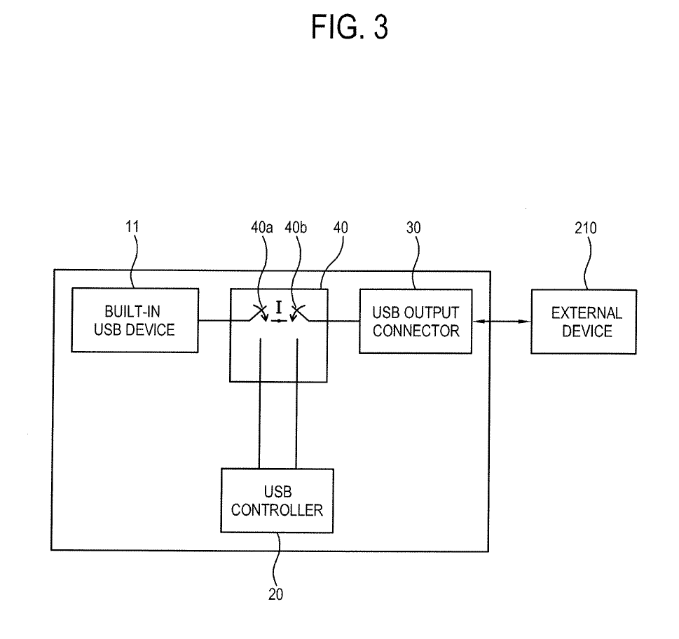

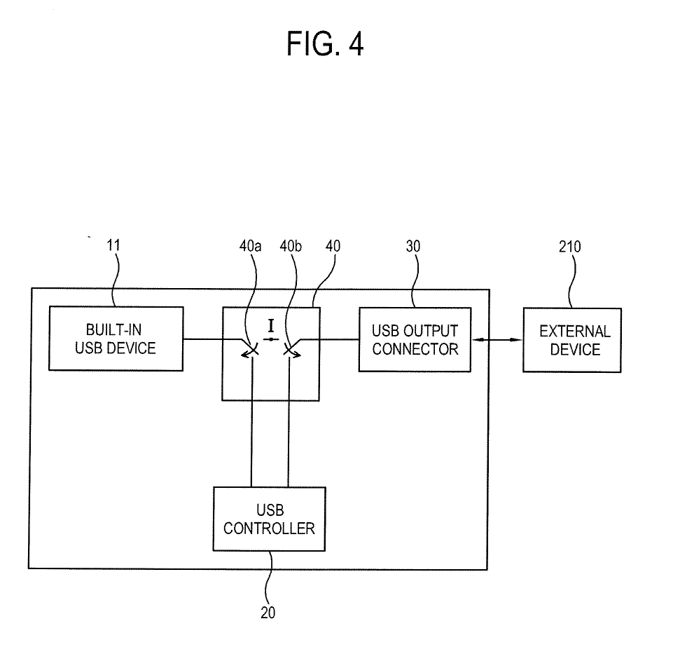

The switch 40 can be provided and communicatively coupled between the built-in USB devices 10, the USB output connector 30 and the USB controller 20, and is switched on and off by a control of the controller 50. The switch 40 can include a plurality of switches which can be connected to each of the built-in USB devices 10. FIGS. 3 and 4 illustrate a first state and a second state of the switch 40 according to exemplary embodiments of the present general inventive concept. That is, FIG. 3 illustrates the first state of switch 40, and FIG. 4 illustrates the second state of switch 40. FIGS. 3 and 4 illustrate only one built-in USB device 11 for convenience. As illustrated therein, the switch 40 includes a first switch 40a to connect the built-in USB device 11 to the USB controller 20 or a predetermined node I, and a second switch 40b to connect the USB output connector 30 to the USB controller 20 or the node I. The connection relationship between the switches will be described later in detail.

The controller 50 can control the switch 40 to connect the built-in USB device 11 to the USB controller 20 or the USB output connector 30 according to one or more predetermined conditions. When the built-in USB device 11 is connected to the USB controller 20, the all-in-one computer 100 may execute a function of the built-in USB device 11. When the built-in USB device 11 is connected to the external device 210 through the USB output connector 30 instead of to the internal USB controller 20, the external device 210 may execute the function and/or operation of the built-in USB device 11 of the all-in-one computer 100. For example, it is assumed that the built-in USB device 11 may be a touch panel operating on a surface of a display unit. The display unit of the all-in-one computer may be connected to another external computer, and the function and/or operation of the touch panel can be performed only in the all-in-one computer. The all-in-one computer 100 according to the exemplary embodiments of the present general inventive concept may provide the function and/or operation of the touch panel to the external device 210, and a user may use a display apparatus having a touch function even though he/she does not have an additional display apparatus having a touch panel. A user may typically have to separately purchase USB devices such as a microphone or a digital camera, that may be connected to a computer. Also, a cable and an adaptor can be added to connect the USB device to the computer, which may increase installation space or time, as well as a user's inconvenience arising from installing such additional devices. When the all-in-one computer 100 according to the exemplary embodiments of the present general inventive concept is used, a user may also use the familiar function of the all-in-one computer 100 from another external computer.

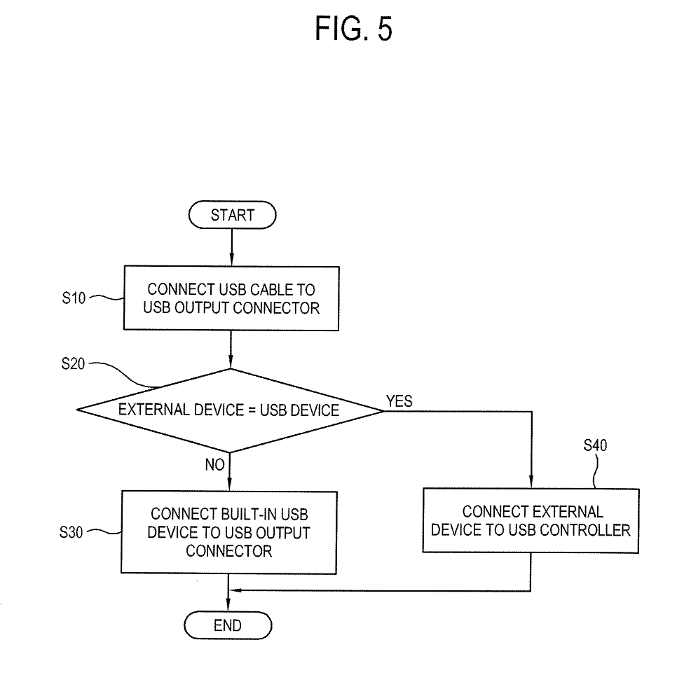

FIG. 5 is a control flowchart illustrating a control method of the computer integrated display (i.e., the all-in-one computer 100) according to exemplary embodiments of the present general inventive concept. The operation of the switch 40 by the controller 50 will be described with reference to FIGS. 3 to 5.

When a user connects the USB cable, e.g., one end thereof, to the USB output connector 30 at operation S10, the controller 50 can determine whether the external device 210 which is connected to an opposite end of the USB cable is the USB device at operation S20. According to exemplary embodiments of the present general inventive concept, the USB output connector 30 and the existing USB input connector can be the same shape. The controller 50 may identify an ID of the external device 210 to determine whether the external device 210 is the USB device.

When it is determined that the external device 210 is not the USB device, t the external computer may be connected as the external device 210. The controller 50 can control the switch 40 to connect the built-in USB device 11 to the USB output connector 30 at operation S30. More specifically, as illustrated in FIG. 3, the controller 50 can control the first switch 40a to connect the built-in USB device 11 to the node I, and can control the second switch 40b to connect the node I to the USB output connector 30. When both the first switch 40a and the second switch 40b are connected to the node I, a signal transmission route can be formed between the built-in USB device 11 and the USB output connector 30, and the built-in USB device 11 can be connected to the external device 210.

The external device 210 can determine that a typical USB device is connected from the outside, and can install a USB driver and drives the built-in USB device 11.

When it is determined that the external device 210 is the USB device, the controller 50 can control the switch 40 to connect all USB devices, including the built-in USB device 11, to the USB controller 20 at operation S40. As illustrated in FIG. 4, the first switch 40a can be switched so as to connect the built-in USB device 11 to the USB controller 20, and the second switch 40b can be switched so as to connect the externally-connected USB device to the USB controller 20. That is, FIG. 4 illustrates that a typical USB device (e.g., external USB device 210) can be connected to the all-in-one computer 100 from the outside, and the external USB device 210 can be driven by the all-in-one computer 100.

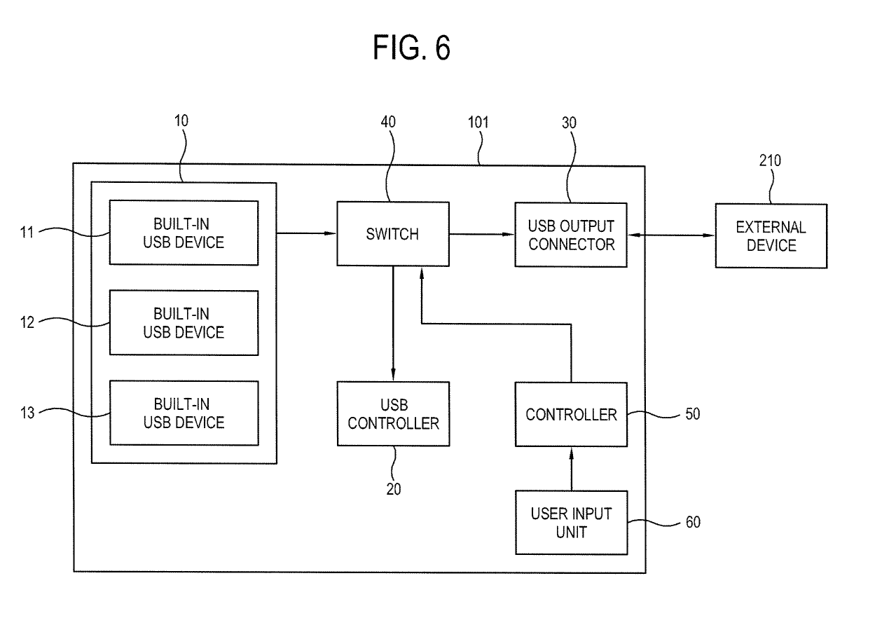

FIG. 6 is a control block diagram illustrating a computer integrated display (i.e., an all-in-one computer) according to exemplary embodiments of the present general inventive concept. As illustrated therein, an all-in-one computer 101 can include a user input unit 60, as well as built-in USB devices 10 (e.g., built-in USB device 11, built-in USB device 12, and built-in USB device 13), USB controller 20, USB output connector 30, switch 40, and controller 50. The user input unit 60 can be a user interface (UI) to generate a control signal by a user. The user input unit 60 may include a hot key, a mouse, a keyboard, a touch pad or a touch panel which may be connected to a computer system, or a remote controller including a plurality of buttons, or any other suitable input device to receive a selection from a user. The all-in-one computer 101 may be communicatively coupled to the external device 210.

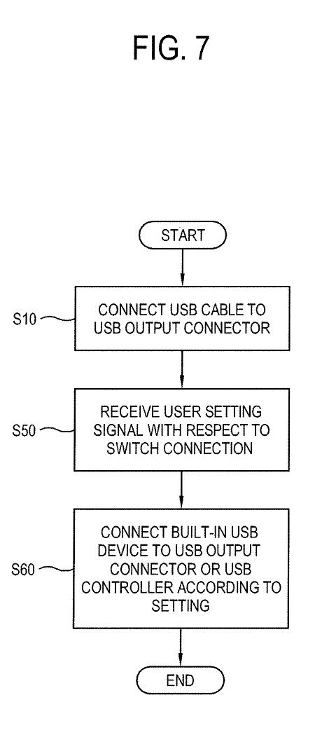

FIG. 7 is a control flowchart illustrating a control method of the all-in-one computer 101 according to exemplary embodiments of the present general inventive concept. The method of controlling the switch 40 according to a user's input will be described with reference to FIG. 7.

When the USB cable is connected to the USB output connector 30 at operation S10, the controller 50 may provide an interface for a user to input a setting signal with respect to the switch connection. That is, the user interface provided by the user input unit 60 may receive a selection from a user to set a switch connection position.

A user may change a connection state of the switch 40 by changing a setting of a basic input output system (BIOS) or other suitable input/output device that may be a controller, application specific integrate circuit, programmable logic device, or field programmable gate array.

When a setting signal for the switch connection is received from a user at operation S50, the controller 50 can control to connect the built-in USB device 10 to the USB controller 20 or the USB output connector 30 according to the setting received by the user input unit 60 at operation S60.

The order of the operations S10 and S50 may change. When a selection of a setting of the BIOS is received (e.g., a selection to change a setting of the BIOS is received), the USB cable may be connected to the USB output connector 30.

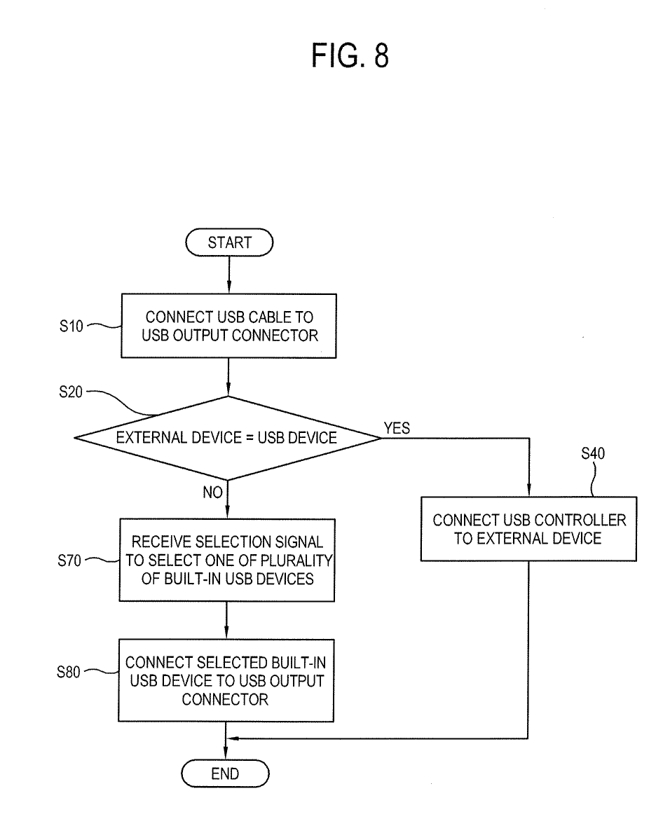

FIG. 8 is a control flowchart illustrating a control method of the all-in-one computer 101 according to exemplary embodiments of the present general inventive concept.

When the USB cable, e.g. one end thereof, is connected to the USB output connector 30 at operation S10, the controller 50 can determine whether the external device 210 which is connected to an opposite end of the USB cable is the USB device at operation S20.

When it is determined that the external device 210 is the USB device, the controller 50 can control the switch 40 to connect the external device 210 to the USB controller 20 at operation S40. The above process is the same as that in the exemplary embodiments of the present general inventive concept illustrated in FIG. 5 and described above.

When it is determined that the external device 210 is not the USB device and that the built-in USB device 10 is be connected to the USB output connector 30, the controller 50 can receive a selection signal to select one of the plurality of built-in USB devices 10 through the user input unit 60 at operation S70.

When the all-in-one computer 101 includes the plurality of built-in USB devices such as a camcorder, a microphone, and a touch panel, a user may set one or more of the built-in USB devices to be used from the external computer. Such setting may be changed according to user input received from the user input unit 60 at any time. When the USB cable is connected to the USB output connector 30, a specific built-in USB device which is connected to the USB output connector 30 may be set as a default.

According to the selection signal, one of the built-in USB devices 10 can be connected to the USB output connector 30 at operation S80.

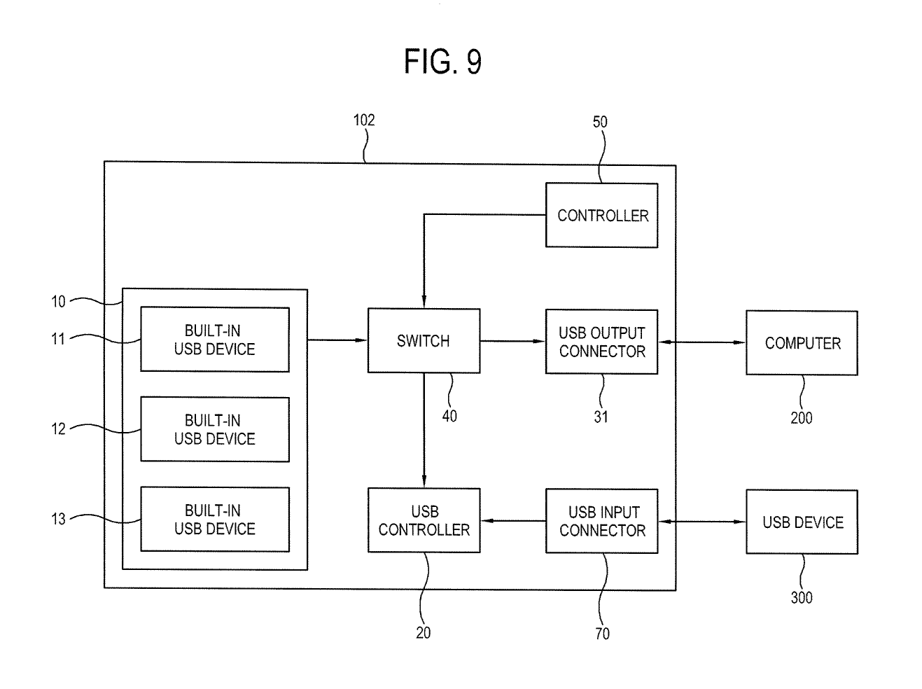

FIG. 9 is a control block diagram illustrating a computer integrated display (i.e., all-in-one computer) according to exemplary embodiments of the present general inventive concept.

An all-in-one computer 102 can include a USB output connector 31 to connect the built-in USB devices 10 (e.g., built-in USB device 11, built-in USB device 12, and built-in USB device 13) to a computer 200, and a USB input connector 70 to connect a USB device 300 thereto. The USB output connector 31 and the USB input connector 70 according to the exemplary embodiments of the present general inventive concept can have different shapes with each other. That is, the all-in-one computer 102 can include the USB output connector 31 which has a different shape from the USB port for which an existing USB device may be used. The all-in-one computer 102 can include USB controller 20, USB output connector 30, switch 40, and controller 50, which are described in detail above.

When the USB cable, e.g. one end thereof, is connected to the USB output connector 31, the controller 50 may not identify an ID of an external device that is connected to an opposite end of the USB cable. The controller 50 may connect the built-in USB device 10 to the USB output connector 31 when it is identified that the USB cable is connected to the USB output connector 31.

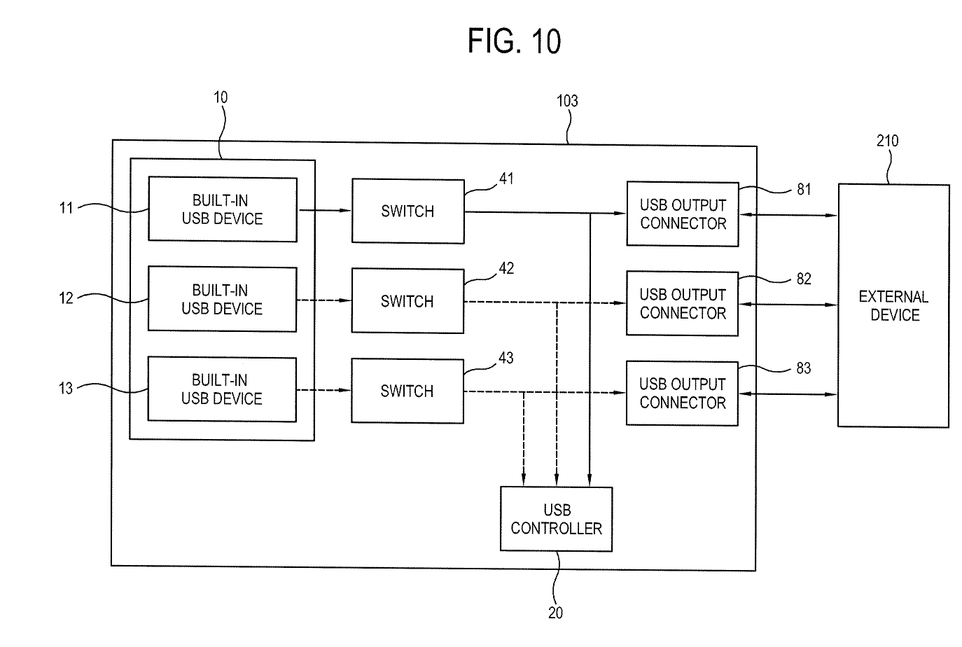

FIG. 10 is a control block diagram illustrating a computer integrated display according to another exemplary embodiment of the present invention. As illustrated therein, an all-in-one computer 103 can include a plurality of USB output connectors 81, 82, and 83. The number of the USB output connectors 81, 82, and 83 may correspond to the number of built-in USB devices 10 (e.g., built-in USB device 11, built-in USB device 12, and built-in USB device 13). An external device 210 may use a plurality of functions of the all-in-one computer 103. A process of selecting one of the plurality of built-in USB devices 10 may be omitted. As each of the plurality of built-in USB devices 10 may match each of the plurality of USB output connectors 81, 82, and 83, the USB output connectors 81, 82, and 83 corresponding to the built-in USB devices 10 may have different shapes with one another.

The all-in-one computer 103 can include USB controller 20 and controller 50, which are described in detail above. The all-in-one computer 103 can include switch 41, switch 42, and switch 43. The switch 41 may control the connection of the built-in USB device 11 to the USB output connector 81 and the USB controller 20. The switch 42 may control the connection of the built-in USB device 12 to the USB output connector 82 and the USB controller 20. The switch 43 may control the connection of the built-in USB device 13 to the USB output connector 83 and the USB controller 20.

The exemplary embodiments of the present general inventive concept support a function of a USB device to be used in an external computer as well as in an all-in-one computer.

As described above, a computer integrated display and a control method of the same according to exemplary embodiments of the present general inventive concept provide a function of a built-in USB device to the outside.

A computer integrated display and a control method of the same according to exemplary embodiments of the present general inventive concept receives a selection of a function of a built-in USB device to be provided to the outside.

A computer integrated display and a control method of the same according to exemplary embodiments of the present general inventive concept shares a display unit having a touch panel function with an external device.

Although several exemplary embodiments have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. A computer integrated display comprising:
at least one built-in universal serial bus (USB) device;
a USB controller to control the at least one built-in USB device;
a USB output connector which is connected to a USB cable;
a switch; and
a controller to control the switch to connect the at least one built-in USB device to the USB controller or the USB output connector.

2. The computer integrated display according to claim 1, further comprising:
a user input unit to set a connection of the switch,
wherein the controller connects the at least one built-in USB device to the USB controller or the USB output connector according to a setting by the user input unit.

3. The computer integrated display according to claim 1, wherein the USB output connector is different in shape from a USB input connector which is connected to an external USB device.

4. The computer integrated display according to claim 3, wherein the controller connects the at least one built-in USB device to the USB output connector when the USB output connector is connected to the USB cable.

5. The computer integrated display according to claim 1, wherein the USB output connector has the same shape as a USB input connector that is connected to an external USB device.

6. The computer integrated display according to claim 5, wherein the controller determines whether an external device connected to an end of the USB cable is a USB device when the USB output connector is connected to an opposite end of the USB cable, and connects the at least one built-in USB device to the USB output connector when it is determined that the external device is not the USB device.

7. The computer integrated display according to claim 5, wherein the switch comprises:
a first switch to connect the at least one built-in USB device to the USB controller or a predetermined node, and
a second switch to connect the USB output connector to the USB controller or the node.

8. The computer integrated display according to claim 7, wherein the controller determines whether an external device connected to one end of the USB cable is a USB device when the USB output connector is connected to an opposite end of the USB cable, and connects the first and second switches to the node when it is determined that the external device is not the USB device.

9. The computer integrated display according to claim 7, wherein the controller determines whether an external device connected to one end of the USB cable is a USB device when the USB output connector is connected to an opposite end of the USB cable, and controls the first and second switches to connect the built-in USB device and the USB output connector to the USB controller when it is determined that the external device is the USB device.

10. The computer integrated display according to claim 1, wherein the at least one built-in USB device includes two or more USB devices, and the number of the USB output connector corresponds to the number of the two or more built-in USB devices.

11. The computer integrated display according to claim 1, wherein the at least one built-in USB device includes two or more USB devices, further comprising:
a user input unit which is provided to connect one of the at least two built-in USB devices to the USB output connector.

12. The computer integrated display according to claim 1, wherein the at least one built-in USB device comprises:
at least one of a touch panel, a camera, a microphone and a speaker.

13. A control method of a computer integrated display which comprises at least one built-in universal serial bus (USB) device, a USB controller to control the built-in USB device, and a USB output connector to connect a USB cable, the control method comprising:
determining whether an external device that is connected to one end of the USB cable is a USB device when the USB output connector is connected to an opposite end of the USB cable; and
connecting the at least one built-in USB device to the USB output connector when it is determined that the external device is not the USB device.

14. The control method according to claim 13, wherein the at least one built-in USB device includes two or more USB devices, further comprising:
receiving a selection signal to connect one of the two or more built-in USB devices to the USB output connector.

15. A control method of a computer integrated display which comprises at least one built-in universal serial bus (USB) device, a USB controller to control the built-in USB device, and a USB output connector to connect a USB cable, the control method comprising:
receiving a setting signal to connect the built-in USB device to the USB controller or the USB output connector; and
connecting the built-in USB device to the USB controller or the USB output connector according to the setting signal.

16. The control method according to claim 15, wherein the at least one built-in USB device comprises:
at least one of a touch panel, a camera, a microphone, and a speaker.

17. The control method according to claim 13, wherein the at least one built-in USB device comprises:
at least one of a touch panel, a camera, a microphone, and a speaker.

18. A method of controlling a computer integrated display including at least one built-in universal serial bus (USB) device, a USB controller to control the at least one built-in USB device, and a USB output connector, the method comprising:
determining whether an external device that is communicatively coupled to the computer integrated display is a USB device;
when it is determined that the external device is not a USB device, connecting the external device to a USB output connector to receive input from the external device and to control the at least one built-in USB device; and
when it is determined that the external device is a USB device, connecting the external device to the USB controller to receive input from the external device and to control the at least one built-in USB device.

19. The method of claim 18, wherein the at least one built-in USB device includes two or more USB devices, and the received input from the external device comprises:
receiving a selection from the external device of at least one of the two or more built-in USB devices; and
controlling the operation of the selected built-in USB devices with the external device.

20. The method of claim 18, further comprising:
switching between the USB output connector and the USB controller according to the determination of whether the external device that is communicatively coupled to the computer integrated display is a USB device.
